(19) United States
(12) Patent Application Publication
(10) Pub. No.: US 2019/0139036 A1
(43) Pub. Date: May 9, 2019

(54) METHOD, APPARATUS, AND COMPUTER-READABLE MEDIUM FOR SECURELY PERFORMING DIGITAL ASSET TRANSACTIONS

(71) Applicant: Aid Technology Limited, Dublin (IE)

(72) Inventors: Alejandro Vicente Grabovetsky, Helsinki (FI); Nicola Paoli, Dublin (IE); Joseph Thompson, Dunboyne (IE); Niall Dennehy, Dublin (IE)

(21) Appl. No.: 16/180,625

(22) Filed: Nov. 5, 2018

Related U.S. Application Data
(60) Provisional application No. 62/581,274, filed on Nov. 3, 2017.

(51) Int. Cl. G06Q 20/38; G06Q 20/32

(52) U.S. Cl. CPC G06Q 20/389; G06Q 20/3829; G06Q 20/20; G06Q 2220/00; G06Q 20/3274

(57) ABSTRACT

An apparatus, method and computer-readable medium for performing digital asset aid transactions comprising receiving a beneficiary code associated with a beneficiary from a merchant computing device, the beneficiary code comprising a beneficiary identifier, converting the beneficiary identifier into an instance of a beneficiary data structure, the beneficiary data structure comprising a beneficiary address in a distributed ledger, transmitting biographical information corresponding to the beneficiary to the merchant computing device, receiving a confirmation message from the merchant computing device confirming an identity of the beneficiary and indicating physical assets for transfer to the beneficiary, generating transactions transferring digital assets corresponding to the physical assets from the beneficiary address to a merchant address in the distributed ledger.

### RELATED APPLICATION DATA

This application claims priority to U.S. Provisional Application No. 62/581,274 filed Nov. 3, 2017, the disclosure of which is hereby incorporated by reference in its entirety.

### BACKGROUND

International aid can include the voluntary transfer of resources from one country to another country or from citizens of one country to citizens of another country. International aid can be extended for many reasons, including diplomatic ties or alliances, positive reinforcement for governmental behavior, to assist in commercial transactions, or for humanitarian or altruistic purposes. More broadly, aid can also include intra-national aid such as assistance offered by one region of a country to another region in times of hardship or in the event of a natural disaster.

There are currently several problems with the distribution of aid to recipients, particularly foreign aid to recipients and beneficiaries abroad. Non-governmental Organizations (NGOs) and governments lose a great deal of cash and funding due to a lack of transparency and inefficiencies in aid distribution systems. Approximately 1.1 trillion dollars are lost each year due to illicit outflows of aid money, such as losses due to fraud and local corruption. Consequently, there is currently no way to securely ensure that aid funding is reaching the intended beneficiaries and that the intended beneficiaries are utilizing the funds in the intended manner. Additionally, there are large quantities of people without official identities who are in need of aid and large quantities of people who are difficult to track due to migration caused by population growth, climate change, and geopolitical events. An additional problem with the distribution of aid to recipients is the lack of any security mechanisms to ensure that funds or personal information are not misused, stolen, or redirected for unauthorized purposes. In sum, there is a lack of transparency, traceability, and security in current aid distribution schemes.

Accordingly, improvements are needed in technology for securely distributing aid that enable governments and NGOs to transparently track the distribution of funds, resources, and social services.

### BRIEF DESCRIPTION OF THE DRAWINGS

FIG. 1 illustrates a flowchart for performing digital asset transactions according to an exemplary embodiment.

FIGS. 2A-2C illustrate examples of beneficiaries redeeming assets using their beneficiary code according to exemplary embodiments.

FIG. 3 illustrates the generation of the beneficiary data structure according to an exemplary embodiment.

FIG. 4 illustrates an example of the beneficiary data structure and the distributed ledger according to an exemplary embodiment.

FIG. 5 illustrates a flowchart for transmitting biographical information corresponding to the beneficiary to the merchant computing device according to an exemplary embodiment.

FIG. 6 illustrates a process flow diagram for retrieving biographical information corresponding to the beneficiary using the beneficiary identifier according to an exemplary embodiment.

FIG. 7 illustrates an example of a beneficiary picture corresponding to a beneficiary being displayed on the merchant computing and point-of-sale device according to an exemplary embodiment.

FIG. 8A illustrates the generation of a transaction according to an exemplary embodiment.

FIG. 8B illustrates the effect of a transaction on the distributed ledger according to an exemplary embodiment.

FIG. 9 illustrates a flowchart for determining the asset information and for generating the transactions based upon asset information according to an exemplary embodiment.

FIG. 10 illustrates a message diagram of the messages passed between various entities during the digital asset transactions described herein according to an exemplary embodiment.

FIG. 11 illustrates a flowchart for settling merchant accounts on the distributed ledger according to an exemplary embodiment.

FIG. 12 illustrates a monetary flow chart of funds in the system for performing digital asset transactions according to an exemplary embodiment.

FIG. 13 illustrates a provisioning workflow according to an exemplary embodiment.

FIG. 14 illustrates an administrative workflow according to an exemplary embodiment.

FIG. 15 illustrates a macro workflow according to an exemplary embodiment.

FIG. 16 illustrates asset transactions and order flow according to an exemplary embodiment.

FIG. 17 illustrates asset transaction stages according to an exemplary embodiment.

FIG. 18 illustrates a process for currency conversion according to an exemplary embodiment.

FIG. 19 illustrates a process for distributing an appeal to multiple beneficiaries according to an exemplary embodiment.

FIG. 20 illustrates a transactions structure for different transactions on the platform according to an exemplary embodiment.

FIG. 21 illustrates an exemplary computing environment that can be used to carry out the method for performing digital asset transactions.

### DETAILED DESCRIPTION

While methods, apparatuses, and computer-readable media are described herein by way of examples and embodiments, those skilled in the art recognize that methods, apparatuses, and computer-readable media for performing digital asset transactions are not limited to the embodiments or drawings described. It should be understood that the drawings and description are not intended to be limited to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “can” is used in a permissive sense (i.e., meaning having the potential to) rather than the mandatory sense (i.e., meaning must). Similarly, the words “include,” “including,” and “includes” mean including, but not limited to.

Applicant has discovered a method, apparatus, and computer-readable medium that solves the problems associated with previous aid distribution platforms. In particular, Applicant has developed an aid distribution platform built upon distributed ledger technology that provides transparency and accountability in the distribution of funds. The aid distribution platform disclosed herein allows for provisioning of beneficiaries with unique identifiers than can then be used to redeem physical assets. In particular, the unique identifiers are utilized by the aid distribution platform to generate an instance of a beneficiary data structure including a private key corresponding to a beneficiary and a location of beneficiary information in a distributed ledger. Subsequent transfers of physical assets to a beneficiary by a merchant are mirrored by the transfer of corresponding digital assets to the merchant from the beneficiary in the distributed ledger. The aid distribution platform disclosed herein utilizes a distributed ledger that is built upon Blockchain technology and allows for tracking of all funds and assets from donors, through NGOs and governments, and ultimately to beneficiaries. Since the ledger is protected by access control rules, this ensures that funds are not lost to corruption, theft, or inefficiencies.

The novel digital asset storage and digital asset allocation techniques disclosed herein provides a secure channel by which aid can be distributed to intended beneficiaries and allows for traceability of funds, traceability of beneficiaries and an asset usage, secure storage of asset allocations in a distributed ledger, and protection of the distributed ledger through access control rules, cryptographic keys, and consensus based updates to the distributed ledger.

As used herein, a beneficiary is a recipient of aid such that the beneficiary does not pay for the received goods or services out of pocket but rather receives the goods or services as a part of a distribution of aid. A beneficiary is distinct from a customer, who provides payment for a received good or service. Physical assets can include consumer goods, produce, water, food, social services, or any other physical item. A beneficiary can be a single individual or can be a include group of individuals.

While disclosed embodiments are generally described in the context of an aid distribution platform, a person of ordinary skill in the art would understand that embodiments provide a digital asset transaction platform that may be implemented in various ways. In an asset distribution platform, a beneficiary or asset recipient may be any individual, group of individuals, or other entity that receives a transferred asset. Likewise, a merchant or asset transferor may be any individual, group of individuals, or other entity that transfers the asset to a beneficiary or asset recipient. Accordingly, a person of ordinary skill in the art would understand that the following embodiments, while described in the context of aid distribution are not so limited and may be used for various types of asset transfer.

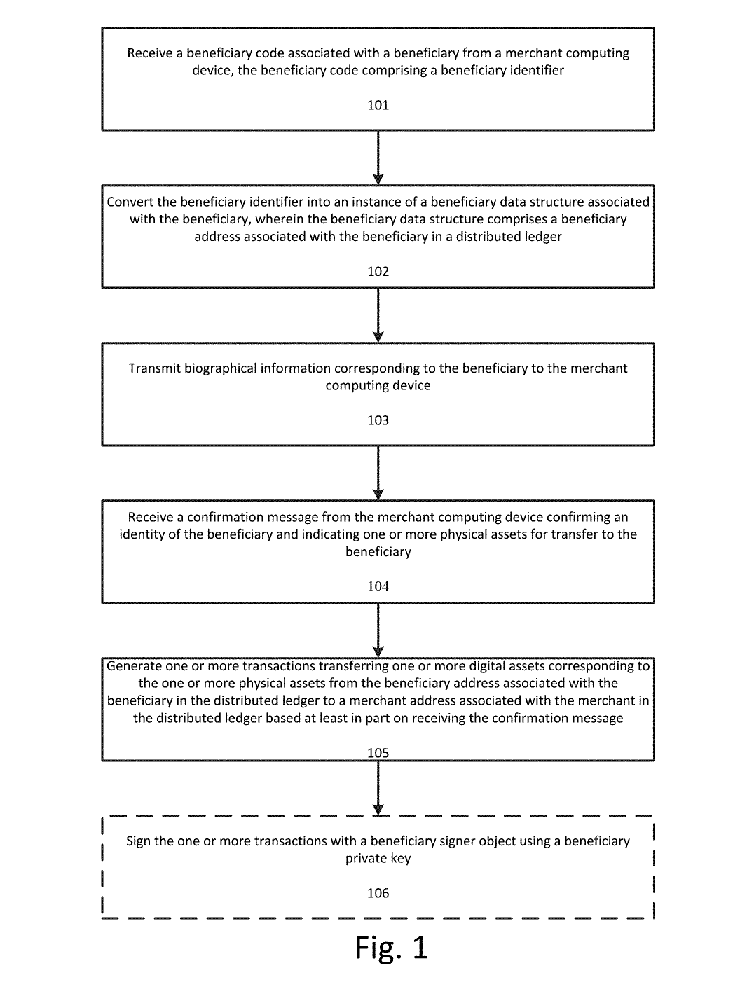

FIG. 1 illustrates a flowchart for performing digital asset transactions according to an exemplary embodiment. At step 101 a beneficiary code associated with a beneficiary is received from a merchant computing device, the beneficiary code comprising a beneficiary identifier. As discussed above, the beneficiary can be a recipient of aid that provides the beneficiary code to redeem all or part of the aid designated for that beneficiary. Alternatively, at step 101, a recipient code can be received corresponding to a recipient that that is not a beneficiary, such as a customer, gift recipient, and/or any other person who is entitled to claim particular assets. For example, the recipient can be a consumer that purchased an item online and wishes to redeem the purchase in-store using a recipient code. The recipient code can include a recipient identifier.

The beneficiary code or recipient code can be any type of code, such as a bar code, a two-dimensional matrix code, an alphanumeric code, a numeric code, etc. The beneficiary identifier can be a value that serves to identify the beneficiary (or a member of the beneficiary group when the beneficiary is a group of people), or recipient and can be contained within the beneficiary code or recipient code and/or can be derivable from the beneficiary code or recipient code, such as by parsing the code and applying one or more transformations to the parsed data.

The beneficiary code or recipient code can be received by a merchant and the merchant computing device from a beneficiary or recipient when the beneficiary (or a member of the beneficiary group when the beneficiary is a group of people) or recipient is redeeming or acquiring physical assets or items. As used herein, a merchant can include any person, group of persons, automated distribution center (such as an electronic locker), or organization that provides physical assets or items. A merchant can include non-profit, non-governmental, or governmental distribution centers and/or warehouses that provide assets to beneficiaries and/or recipients.

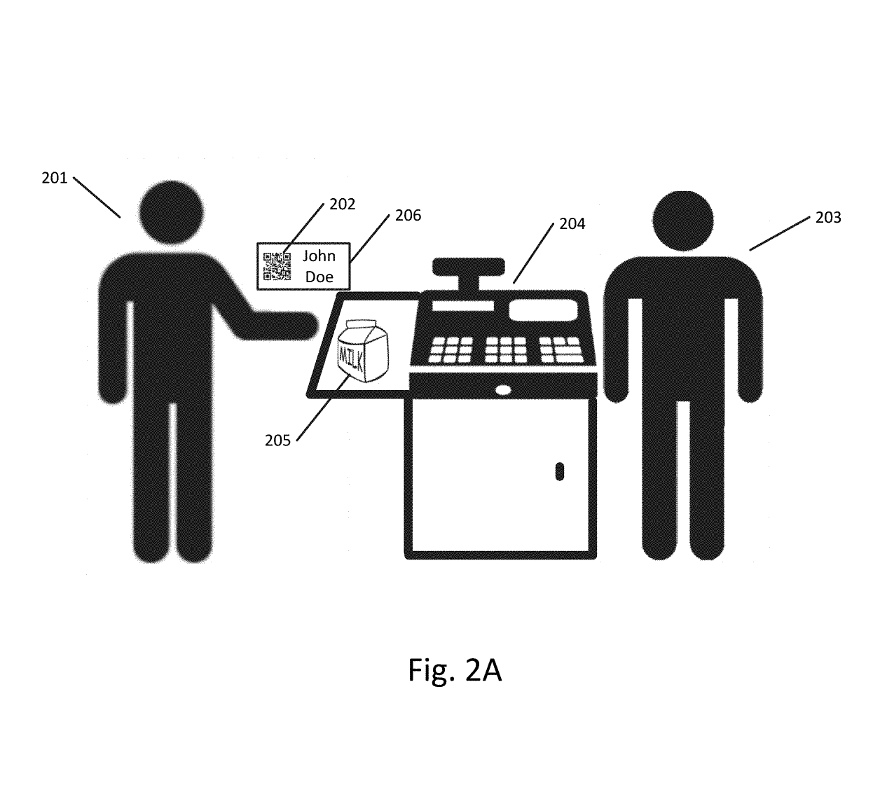

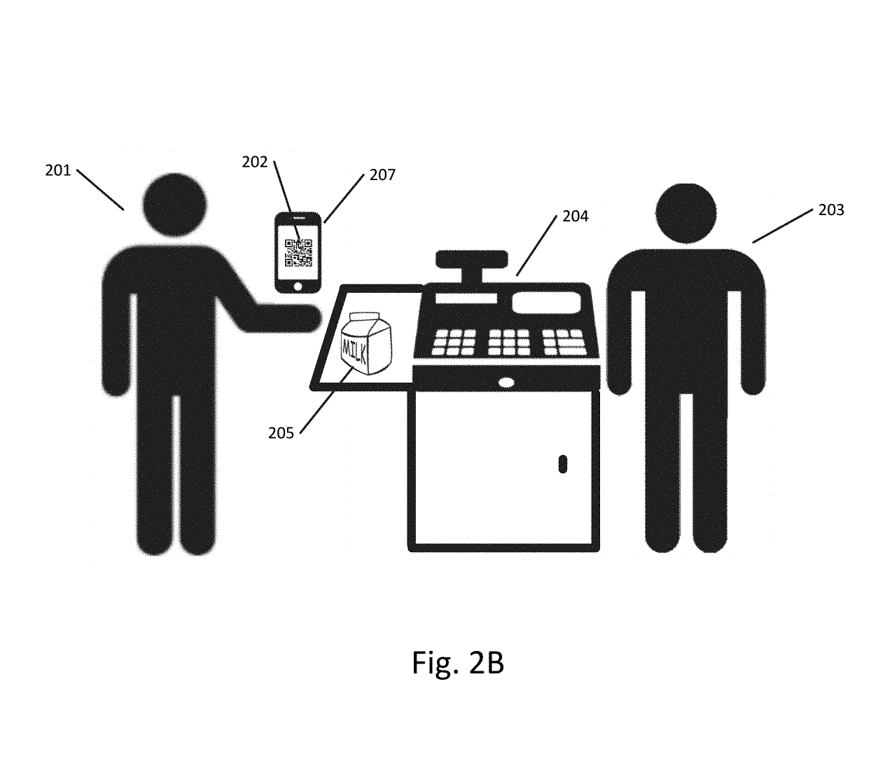

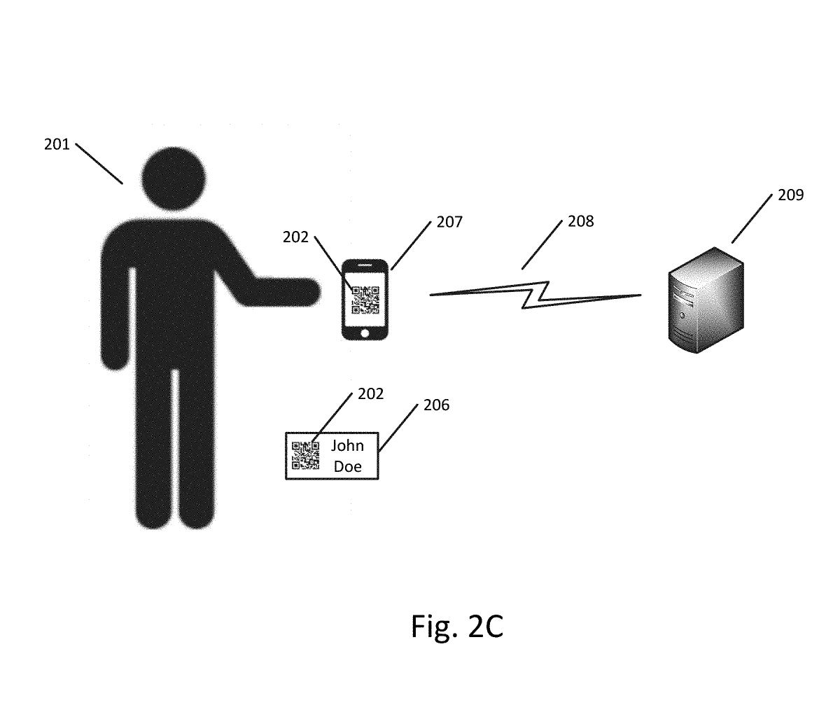

FIG. 2A illustrates an example of a beneficiary redeeming assets using their beneficiary code according to an exemplary embodiment. As shown in FIG. 2A, a beneficiary 201 has presented an identification card 206 including their beneficiary code 202 to a merchant 203. The beneficiary code 202 in FIG. 2A is a Quick Response (QR) code and the beneficiary in this case is attempting to redeem a physical asset of a carton of milk 205. The merchant 203 can scan the beneficiary code 202, such as by using a scanner communicatively coupled to a merchant computing device 204, which is shown as a point of sale terminal. The scanner can optionally be a mobile phone of the merchant 203. After scanning the code, the merchant computing device 204 can transmit the beneficiary code to the digital asset transaction platform, which receives the beneficiary code.

FIG. 2A illustrates the beneficiary code 202 as being printed on a physical identification card 206 of the beneficiary 201, but other variations are possible. FIGS. 2B-2C illustrate additional examples of a beneficiary redeeming assets using their beneficiary code according to exemplary embodiments. As shown in FIG. 2B, the beneficiary code 202 is presented on a mobile device 207 of the beneficiary 201. A web application can be installed on the mobile device 207 that allows the beneficiary 201 to pull up their beneficiary code 202. The merchant 203 can then scan the beneficiary code 202 in the same way as described with respect to FIG. 2A and transmit the beneficiary code to the to the digital asset transaction platform. As shown in FIG. 2C, the beneficiary can also utilize both a mobile device 207 and a physical identification card 206 to redeem assets over a network connection. In this case, the mobile device 207 can be used to scan the beneficiary code 202 and transmit it over a network connection 208 to a merchant computing device 209, which can then forward the beneficiary code 202 on to the digital asset transaction platform.

The beneficiary code can also be transmitted to the merchant terminal in other ways. For example, the beneficiary code can be transmitted from a mobile device of a beneficiary to a merchant terminal using near field communication technologies.

In the scenario where a recipient presents a recipient code to redeem physical assets using an electronic locker, the recipient can scan the recipient code at an electronic terminal. The electronic terminal can transmit the recipient code over the network connection to the digital asset transaction platform. Upon subsequent verification of the transaction by the recipient and/or identity of the recipient, the digital asset transaction platform can communicate with the electronic terminal to unlock an electronic locker containing the designated physical assets.

Returning to FIG. 1, at step 102 the beneficiary identifier is converted into an instance of a beneficiary data structure associated with the beneficiary. The beneficiary data structure includes a beneficiary address associated with the beneficiary in a distributed ledger. The beneficiary data structure can optionally also include a beneficiary private key associated with the beneficiary and a beneficiary signer object configured to sign transactions.

In the case of a non-beneficiary recipient, the recipient identifier can be converted into a recipient data structure associated with the recipient. Similar to the beneficiary data structure, the recipient data structure includes a recipient address associated with the recipient in a distributed ledger, and can optionally also include a recipient private key associated with the recipient and a recipient signer object configured to sign transactions.

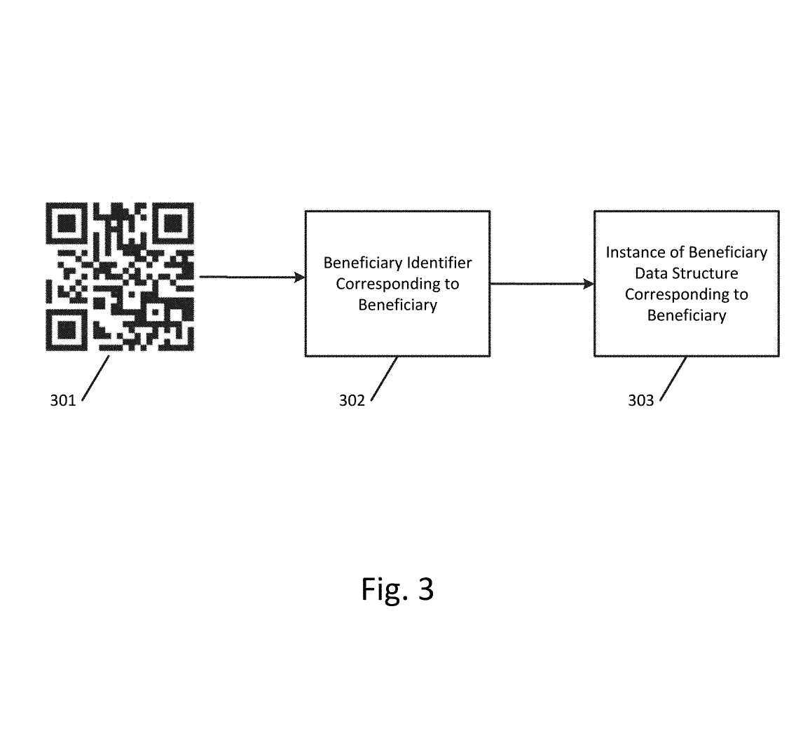

FIG. 3 illustrates the generation of the beneficiary data structure according to an exemplary embodiment. As shown in FIG. 3, the beneficiary code 301 is used to derive or otherwise extract a beneficiary identifier 302 that corresponds to the beneficiary. This beneficiary identifier 302 is then used to generate an instance of a beneficiary data structure corresponding to the beneficiary. A similar process can be used to generate the recipient data structure.

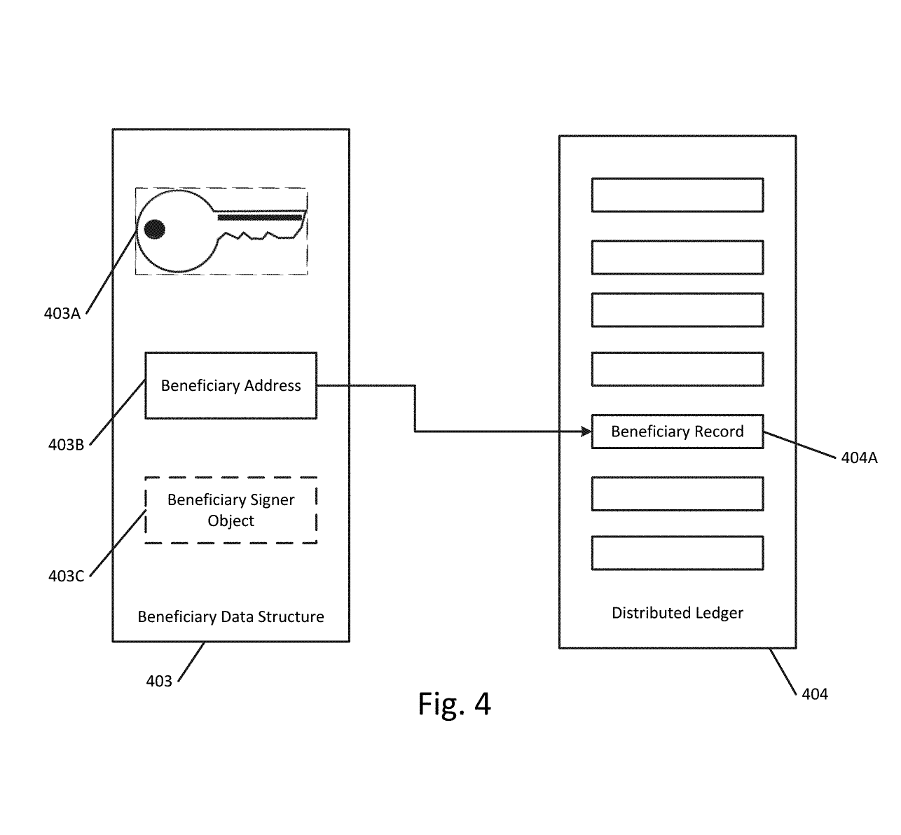

FIG. 4 illustrates an example of the beneficiary data structure and the distributed ledger according to an exemplary embodiment. The beneficiary data structure 403 includes a beneficiary address 403B associated with the beneficiary in a distributed ledger 404. This address 403B identifies a location of a beneficiary record 404A within the distributed ledger 404. Additionally, beneficiary data structure 403 can also optionally include a private key 403A used by the beneficiary to sign transactions and a beneficiary signer object 403C, which is an object that can sign transactions using the private key 403A.

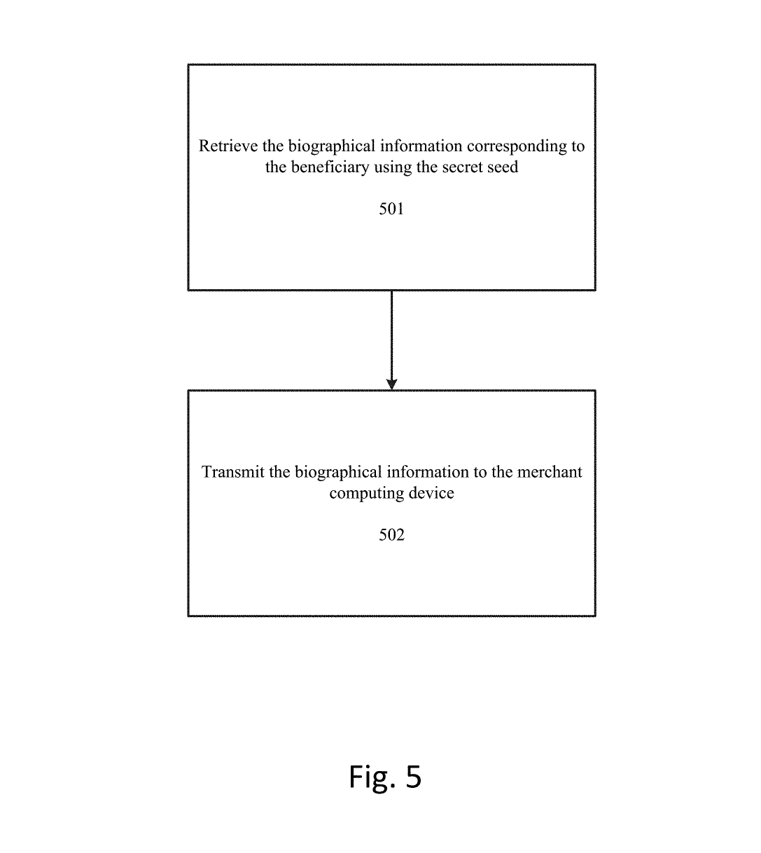

Returning to FIG. 1, at step 103, biographical information corresponding to the beneficiary is transmitted to the merchant computing device. FIG. 5 illustrates a flowchart for transmitting biographical information corresponding to the beneficiary to the merchant computing device according to an exemplary embodiment. Although FIG. 5 is explained with respect to a beneficiary, it is understood that the same process can be utilized to transmit biographical information corresponding to any asset recipient to the merchant computing device.

At step 501, the biographical information corresponding to the beneficiary is retrieved using the beneficiary identifier. The biographical information can be retrieved from different sources. For example, files such as photographs or copies of official documents (such as a passport or utility bill) can be stored in a file storage, such as a binary large object (BLOB) storage and biographical textual information such as name, gender, citizenship, address, date-of-birth, etc. can be stored in the distributed ledger itself or in a SQL database. Both the file storage and the SQL database storing biographical information can be encrypted to protect user privacy.

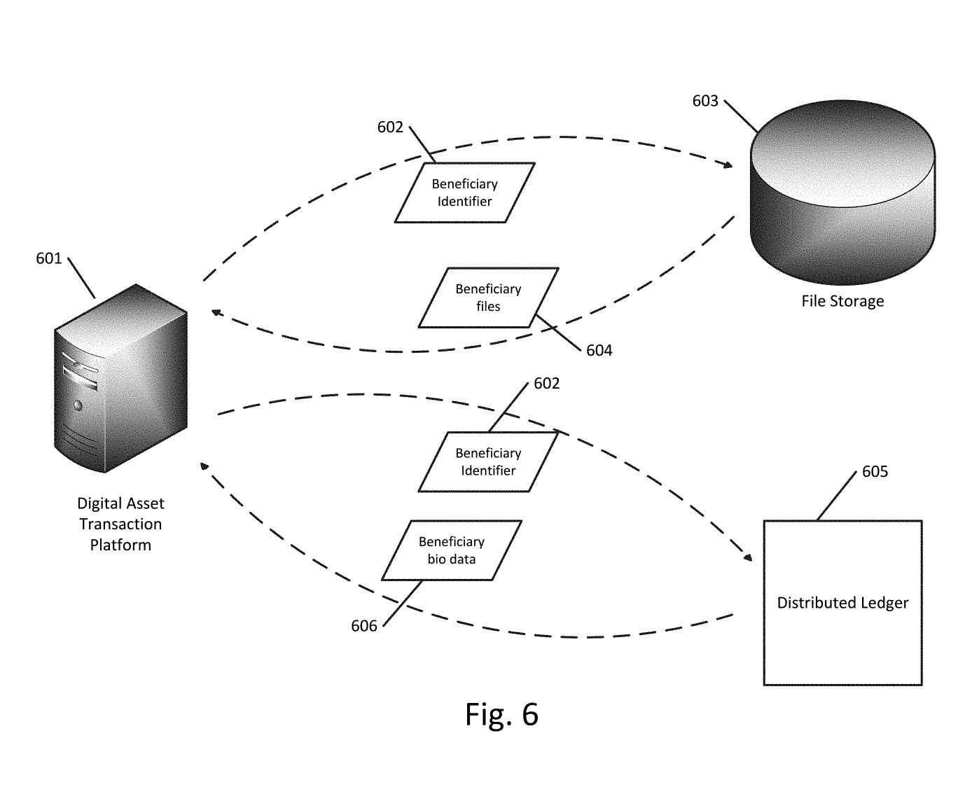

FIG. 6 illustrates a process flow diagram for retrieving biographical information corresponding to the beneficiary using the beneficiary identifier according to an exemplary embodiment. As shown in FIG. 6, the digital asset transaction platform 601 queries a file storage platform 603 using the beneficiary identifier 602 corresponding to the beneficiary and receives the beneficiary files 604 corresponding to the beneficiary in return. The digital asset transaction platform 601 additionally queries the distributed ledger 605 using the beneficiary identifier 602 and receives the beneficiary biographical data 606 corresponding to the beneficiary in return. Although FIG. 6 is explained with respect to a beneficiary, it is understood that the same process can be utilized to retrieve biographical information corresponding to a non-beneficiary recipient using a corresponding identifier.

Returning to FIG. 5, at step 502 the biographical information is transmitted to the merchant computing device. In the case of the process shown in FIG. 6, this would include the biographical files and the biographical data. The biographical files can include a photo of the beneficiary that the merchant can utilize to verify an identity of the beneficiary. In the scenario where the beneficiary is a group of persons, the biographical files and the biographical data can include an identifier of the group or identifiers of individual persons within the group. For example, the biographical files can include photos of all members of the group of persons.

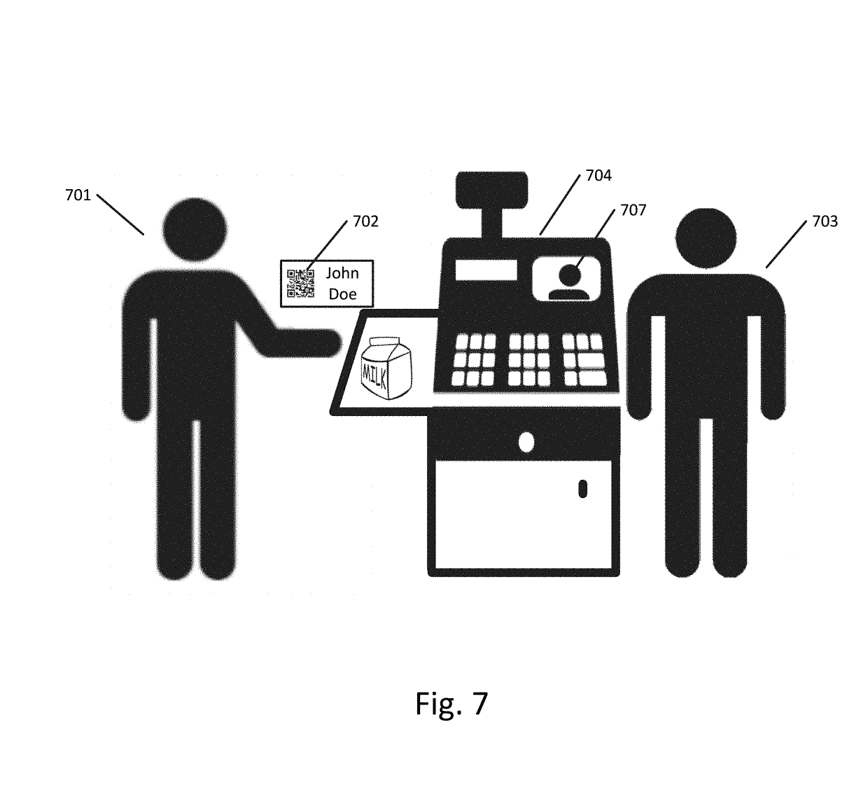

FIG. 7 illustrates an example of a beneficiary picture 707 corresponding to a beneficiary 701 being displayed on the merchant computing and point-of-sale device 704. The merchant 703 can compare the photograph 707 to the beneficiary 701 and determine whether the beneficiary 701 matches the face in the photograph 707.

Returning to FIG. 1, at step 104 a confirmation message is received from the merchant computing device confirming an identity of the beneficiary and optionally indicating one or more physical assets for transfer to the beneficiary. In the case of the scenario shown in FIG. 7, this confirmation can be sent after the merchant 703 has had a chance to confirm that the beneficiary 701 matches their photograph 707. Additionally, the confirmation message can be transmitted by the merchant computing device 704 after the beneficiary has authorized the transaction. The confirmation message can optionally include the beneficiary code 702 of the beneficiary and/or specify a quantity and type of physical asset 705 being acquired, if not previously specified.

The verification and confirmation steps described above can be performed for any asset recipient, including aid beneficiaries. In the example of an asset recipient using an electronic locker, facial information can be transmitted to the electronic terminal and a facial scan can be performed of the asset recipient to provide verification of identity, such as by using facial recognition software within the electronic terminal or at the digital asset transaction platform. The electronic terminal can then transmit confirmation of successful identification to the digital asset transaction platform.

Returning to FIG. 1, at step 105 one or more transactions transferring one or more digital assets corresponding to the one or more physical assets from the beneficiary address associated with the beneficiary in the distributed ledger to a merchant address associated with the merchant in the distributed ledger are generated based at least in part on receiving the confirmation message. Additionally, at step 106, the one or more transactions can optionally be signed with the beneficiary signer object using the beneficiary private key. This additional step provides an extra layer of security to transactions on the distributed ledger. In the case of a non-beneficiary recipient, the same steps can be performed to generate one or more transactions transferring one or more digital assets corresponding to the one or more physical assets from the recipient address associated with the recipient in the distributed ledger to a merchant address associated with the merchant in the distributed ledger.

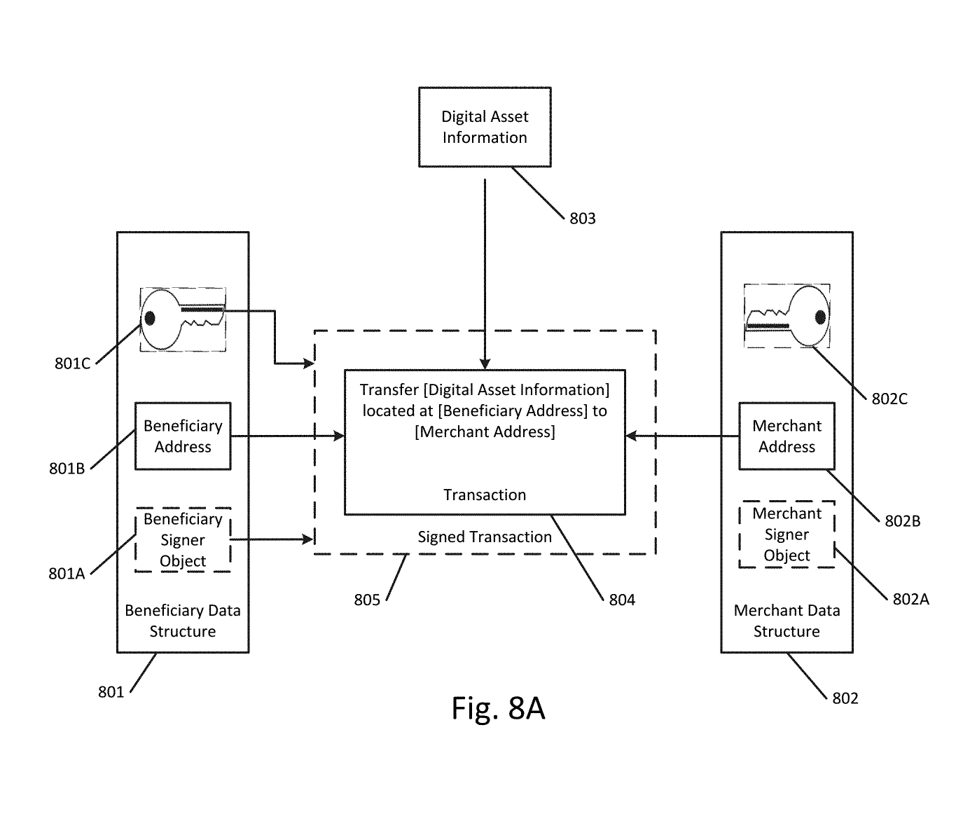

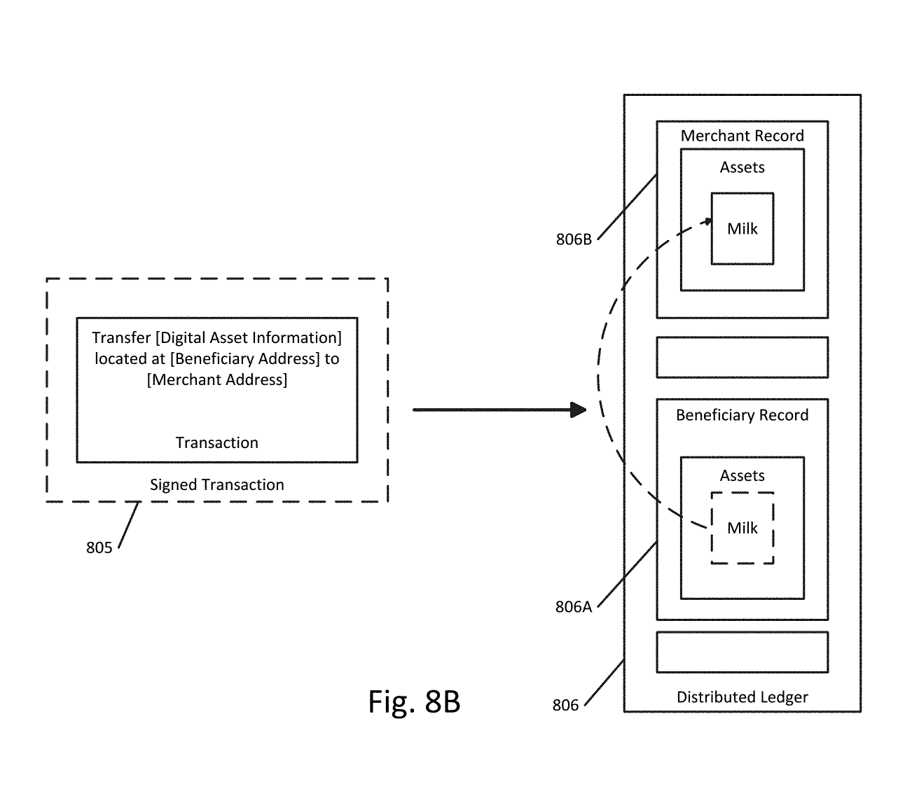

FIGS. 8A-8B illustrate an example of the process of generating and signing transactions according to an exemplary embodiment. Although FIGS. 8A-8B are explained with respect to a beneficiary, it is understood that the same process can be utilized to generate and sign transactions for a non-beneficiary recipient.

As shown in FIG. 8A, an instance of a beneficiary data structure 801 has been generated based on the received beneficiary code and on the beneficiary identifier within or derivable from the received beneficiary code. This beneficiary data structure 801 can be stored at the digital asset transaction platform. As shown in FIG. 8A, the beneficiary data structure 801 includes the beneficiary address 801B that points to an address of a beneficiary data record in a distributed ledger, and can optionally also include a beneficiary signer object 801A and a beneficiary private key 801C used to sign transactions.

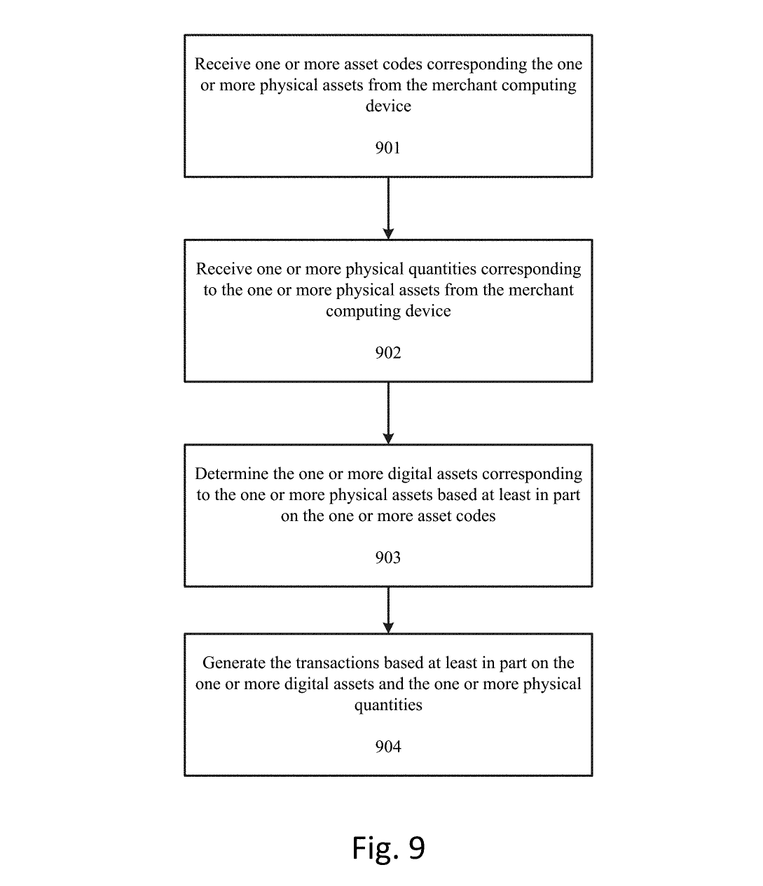

Also shown in FIG. 8A is the digital asset information 803 of one or more digital assets corresponding to the one or more physical assets transferred to the beneficiary. This information can be determined by the digital asset transaction platform based upon information received from the merchant computing device, as described further with respect to FIG. 9.

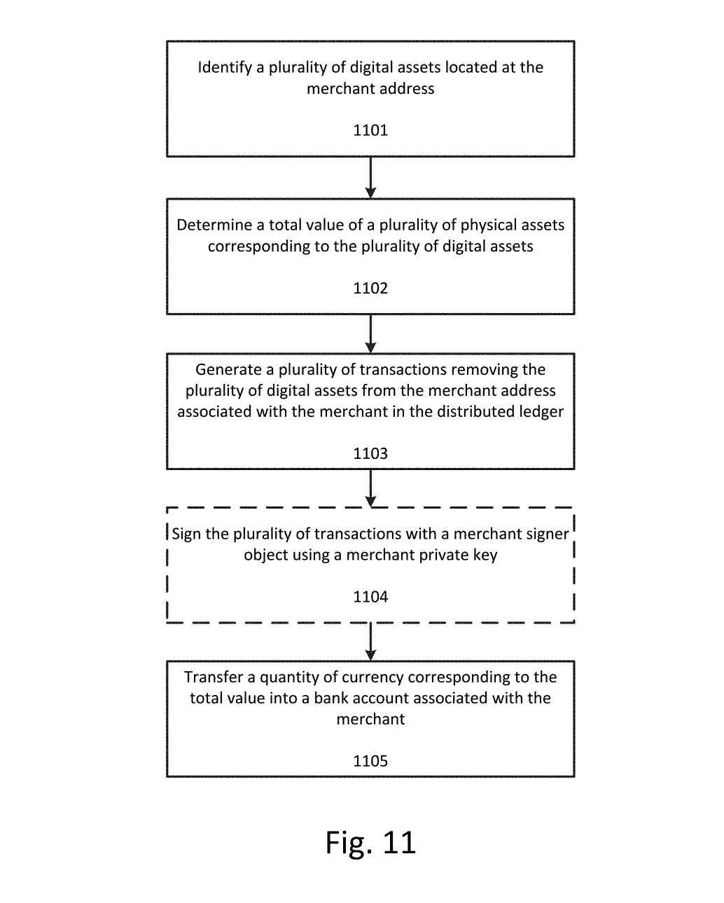

Additionally, FIG. 8A illustrates an instance of merchant data structure 802 including a merchant address 802B of a merchant record in the distributed ledger, and can optionally include a merchant signer object 802A and a merchant private key 802C used for signing merchant redemption transactions, which are discussed further with respect to FIG. 11. The instance of the merchant data structure 802 can be stored on the merchant computing device, and either the merchant address 802B alone or a copy of the entire merchant data structure 802 can be transmitted to the digital asset transaction platform prior to the step of generating one or more transactions.

As shown in FIG. 8A, the digital asset information 803, the beneficiary address 801B, and the merchant address 802B are all used to generate one or more transactions 804. The beneficiary signer object 801A can optionally be utilized with the beneficiary private key 801C to sign the transaction 804, resulting in a signed transaction 805.

FIG. 8B illustrates the effect of the signed transaction 805 on the distributed ledger 806. As shown in FIG. 8B, the distributed ledger includes records corresponding to merchants, such as merchant record 806B and records corresponding to beneficiaries, such as beneficiary record 806A.

The merchant records in the distributed ledger 806 can include information such as Shop Name, Shop Address, First Name, Surname, Date of Birth (DOB), Address, Citizenship, Phone, and/or Email. Additional information about merchants, such as files relating to merchants, can be stored in file storage. The files can include, for example, a picture, a passport copy, and/or a utility bill.

The beneficiary records in the distributed ledger 806 can include information such as First Name, Surname, DOB, Address, Country of Origin, Citizenship, Gender, Phone, and/or Email. Additional information about beneficiaries, such as files relating to beneficiaries, can be stored in file storage. The files can include, for example, a picture, a passport copy, and/or a utility bill.

As shown in FIG. 8B, the distributed ledger is organized in a hierarchical structure, with certain classes of records being subordinate to other classes of records. For example, both merchant records and beneficiary records include sub-records of assets that are assigned to them.

The asset records in the distributed ledger 806 can include information such as Asset Name, Asset Symbol, and Divisibility of the Asset (the number of digits after the comma in the quantity). Additional information about assets, such as files relating to assets, can be stored in file storage. The files can include, for example, a picture of an asset icon.

Additionally, the distributed ledger 806 can include records corresponding to platform administrators that can be responsible for provisioning assets, beneficiaries, and merchants. The platform administrator records can include information such as First Name, Surname, Address, Citizenship, Phone, and Email.

As discussed earlier, the distributed ledger can be built upon a private Blockchain or a public Blockchain, such as the Blockchain utilized for Bitcoin, to ensure irreversibility. A hash of the entire ledger can be committed onto a non-reversible Blockchain such as Bitcoin. In this mode, one transaction is committed in every Bitcoin block, and contains the cumulative hash at the current time. By doing this, even if the platform is processing thousands of transactions per second, only one transaction gets sent to the Bitcoin blockchain every 10 minutes. The irreversibility of the distributed ledger is ensured by the Bitcoin miners, therefore enjoying the same level of irreversibility as Bitcoin itself.

The distributed ledger is a permissioned ledger in that the write permissions are controlled by the issuing organization (such as an NGO or governmental organization). Each approved beneficiary or recipient and each merchant is granted a private key that allows them to sign transactions and thereby ensure that the transactions are written to the ledger. Additionally, in the case of beneficiaries, a closed ecosystem can be utilized in which only the public keys of beneficiaries can be used to send funds to that beneficiary.

Access to the distributed ledger can be governed by access control rules that determine the actions that can be taken on the ledger. For example, access control rules can utilize criteria such as a merchant identifier or ledger address, a beneficiary identifier or ledger address, and/or type and quantity of digital assets for transfer in order to determine whether to permit a particular transaction. Another access control rule can only allow money to be spent for an account by someone who is an “administrator” of that account so that a merchant cannot spend money from an account he does not own (same for a beneficiary, organization admin, etc.). Multiple levels of users can also be utilized (“beneficiary”, “merchant”, “organization admin”, “superadmin”), with each level having different permissions to perform certain types of actions. For example, an “organization admin” can see the transactions of merchants and beneficiaries on the platform, while a “beneficiary” or “merchant” can see only their own transactions. Some rules can be implemented directly on the distributed ledger (e.g., the blockchain) and some can be implemented on the platform.

As shown in FIG. 8B, the transaction 805 (optionally signed) results in the milk asset within the asset records of beneficiary record 806A being transferred to the asset records of merchant record 806B. The addresses for each of the merchant record 806B and the beneficiary record 806A can be specified within the transaction 805, as discussed earlier.

As discussed with respect to FIG. 8A, asset information corresponding to one or more digital assets is used to generate the one or more transactions. FIG. 9 illustrates a flowchart for determining the asset information and for generating the transactions based upon asset information according to an exemplary embodiment.

At step 901 one or more asset codes corresponding the one or more physical assets being provided to the beneficiary or recipient are received from the merchant computing device. The asset codes can be, for example, internal identifiers for certain physical assets, physical asset stock keeping unit (SKU) numbers, physical asset universal product codes (UPCs), or any other identifier of a physical asset. For example, a merchant can scan the UPCs of any physical assets that a beneficiary wishes to redeem.

At step 902 one or more physical quantities corresponding to the one or more physical assets are received. The physical quantities can be received at the same time as the asset codes or afterwards. For example, the merchant can first provide the assets codes and then later provide the physical quantities or provide both together in a single message to the digital asset transaction platform.

At step 903 the one or more digital assets corresponding to the one or more physical assets are determined based at least in part on the one or more asset codes. This information can be stored in a lookup table or database structure and can be stored, for example, as a one-to-one correspondence between physical assets and digital assets. For example, a carton of milk will have a digital asset counterpart.

At step 904 the transactions are generated based at least in part on the one or more digital assets and the one or more physical quantities. This step is described with respect to FIGS. 8A-8B. The quantity information can be incorporated into the transactions in a variety of ways. The transaction record itself can include a quantity field specifying the quantity of digital assets that should be transferred for a particular transaction. Alternatively, a number of transactions corresponding to the quantity can be generated such that each transaction transfers a single unit. Many variations are possible and these examples are not intended to be limiting.

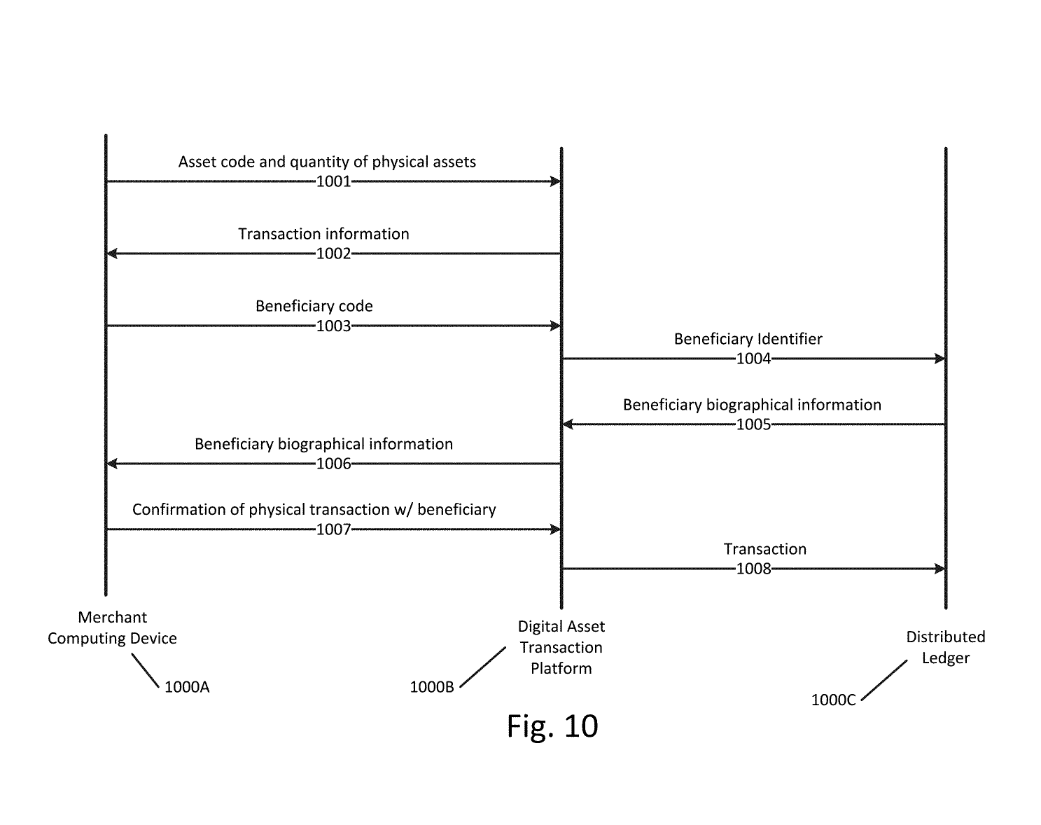

FIG. 10 illustrates a message diagram of the messages passed between various entities during the digital asset transactions described herein according to an exemplary embodiment. Although FIG. 10 is explained with respect to a beneficiary, it is understood that the same messages are passed for a non-beneficiary recipient.

In message 1001, merchant computing device 1000A transmits asset codes and a quantity of physical assets to the digital asset transaction platform 1000B. In message 1002 this transaction information can be sent back to the merchant computing device 1000A for presentation to a beneficiary. The beneficiary can provide the merchant with their beneficiary code, which is sent back to the digital asset transaction platform 1000B in message 1003. The digital asset transaction platform 1000B can query the distributed ledger 1000C with a message 1004 including the beneficiary identifier and receive a message 1005 including the beneficiary biographical information in return. As discussed earlier, the digital asset transaction platform 1000B can also query a file storage platform for relevant files.

The beneficiary biographical information can then be passed in message 1006 from the digital asset transaction platform 1000B to merchant computing device 1000A. At this point, the merchant can confirm the physical transaction with the beneficiary and/or confirm the identity of the beneficiary and transmit confirmation message 1007 back to the digital asset transaction platform 1000B. The digital asset transaction platform 1000B then generates the signed transaction as discussed earlier and applies it to the distributed ledger 1000C. While the distributed ledger 1000C is shown as a distinct entity from the digital asset transaction platform 1000B, this is for purposes of clarity only, and it is understood that the distributed ledger 1000C can be part of, and integrated into, the digital asset transaction platform 1000B.

After a certain period of time, a merchant account may be settled up so that the merchant receives monetary compensation for the physical assets provided to beneficiaries. The merchant essentially sells their corresponding digital assets stored in the distributed ledger back to the NGO or governmental entity providing the aid. This process can be performed periodically (daily, weekly, monthly, etc.) or at the request of the merchant.

FIG. 11 illustrates a flowchart for settling merchant accounts on the distributed ledger according to an exemplary embodiment.

At step 1101 a plurality of digital assets located at the merchant address are identified. The merchant computing device can provide the merchant address to the digital asset transaction platform in order to facilitate the identification of the relevant digital assets.

At step 1102 a total value of a plurality of physical assets corresponding to the plurality of digital assets is determined. This can be based upon a previously agreed upon exchange rate of currency to physical assets or upon a current market value of the physical assets at the time of merchant settlement or upon a current market value of the physical assets at the time of beneficiary redemption.

At step 1103 a plurality of transactions removing the plurality of digital assets from the merchant address associated with the merchant in the distributed ledger are generated. These transactions can transfer the plurality of digital assets from the merchant address to another address within the ledger that is associated with the aid provider (such as the NGO or governmental entity) or an address or addresses associated with beneficiaries of the aid provider. For example, the digital assets can be transferred to a treasury address within the distributed ledger or the digital assets or can be transferred directly to addresses of one or more beneficiaries. If multiple aid providers are utilizing a single distributed ledger, then each aid provider can be assigned its own address and the transactions can transfer digital assets from the merchant address to an address of an aid provider that has an agreement with that merchant. The transactions can be generated on the digital asset transaction platform or on the merchant computing device and then transmitted to the digital asset transaction platform. In the latter case, the relevant address for transfer of the digital assets can be provided to the merchant computing device.

At optional step 1104 the plurality of transactions can be signed with a merchant signer object using a merchant private key. This information can be transmitted from a merchant computing device to the digital asset transaction platform as part of the merchant settlement process. The merchant can also send its own merchant code that can be used to instantiate an instance of a merchant data structure including the merchant address and, optionally, the merchant signer object and the merchant private key. Additionally, the plurality of transactions can also be signed at the merchant computing device and then transmitted to the digital asset transaction platform.

At step 1105 a quantity of currency corresponding to the total value of the plurality of physical assets corresponding to the plurality of digital assets is transferred into a bank account associated with the merchant. This transfer can be from the NGO or governmental entity as it essentially “buys-back” all digital assets redeemed at the merchant. As part of this step, either before or after or simultaneously, the signed transactions are applied to the distributed ledger, resulting the removal of the digital assets from the merchant address associated with the merchant.

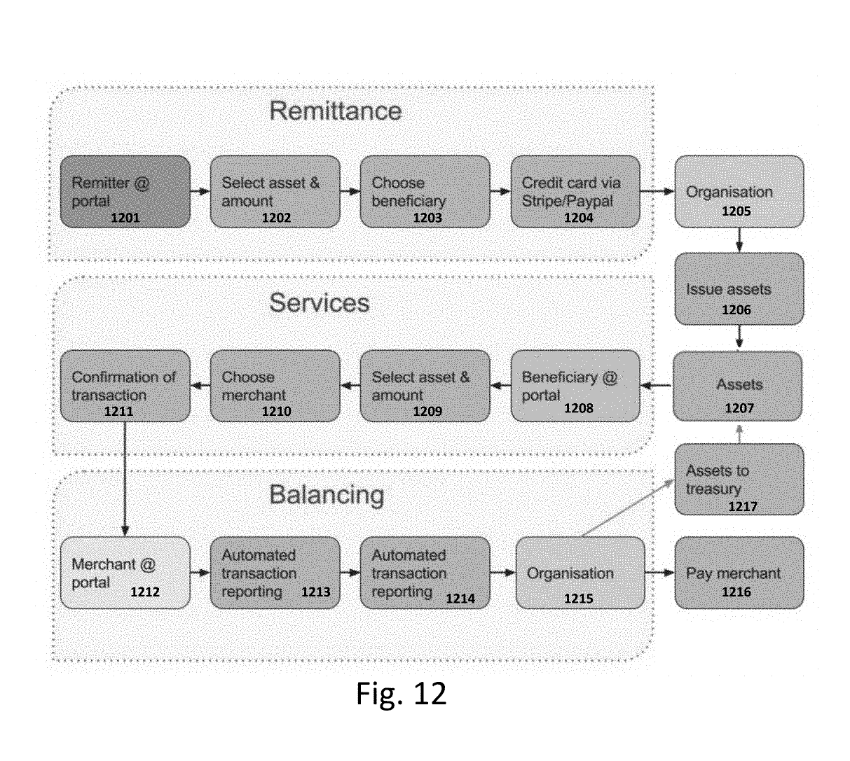

FIG. 12 illustrates a monetary flow chart of funds in the system for performing digital asset transactions according to an exemplary embodiment.

The process begins with the remittance phase. At step 1201 a remitter/donor signs in to a remitter portal. At optional step 1202 selects assets and amounts that they would like to donate. For example, a remitter can choose to provide physical assets such as water, grains, and other essentials. Alternatively, the remitter can select an amount of funds and the specific assets and amounts can be subsequently determined by the aid organization. At optional step 1203 the remitter can optionally choose beneficiaries or groups of beneficiaries to receive aid. If the remitter elects not to select beneficiaries, then the beneficiaries can be selected by the aid organization. The remitter then provides payment at step 1204.

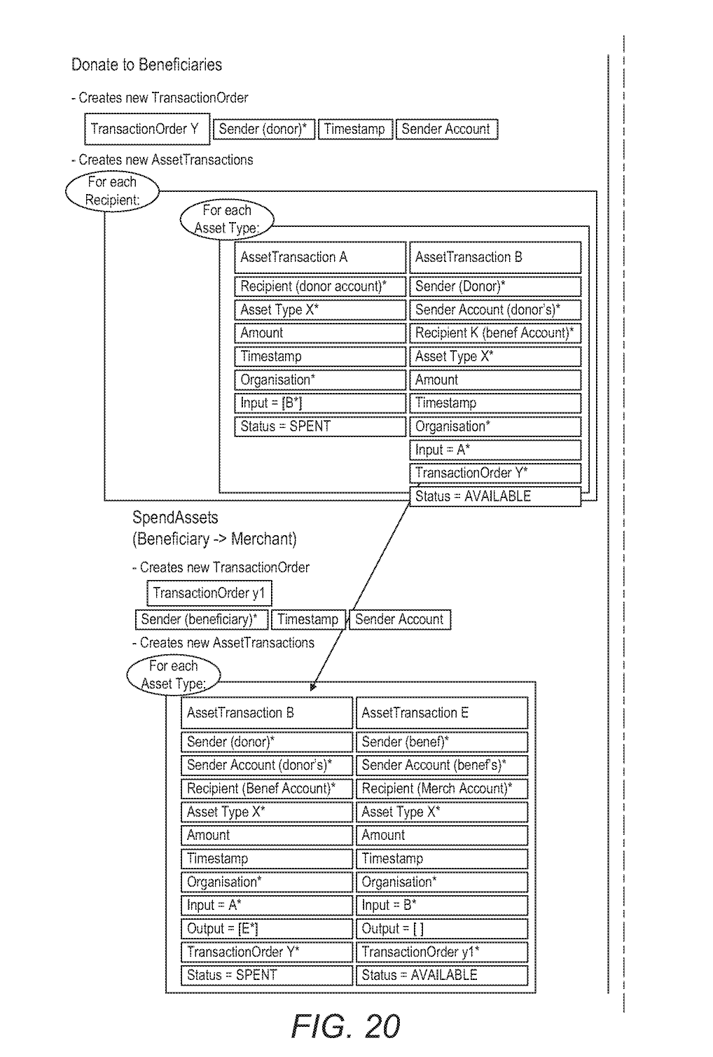

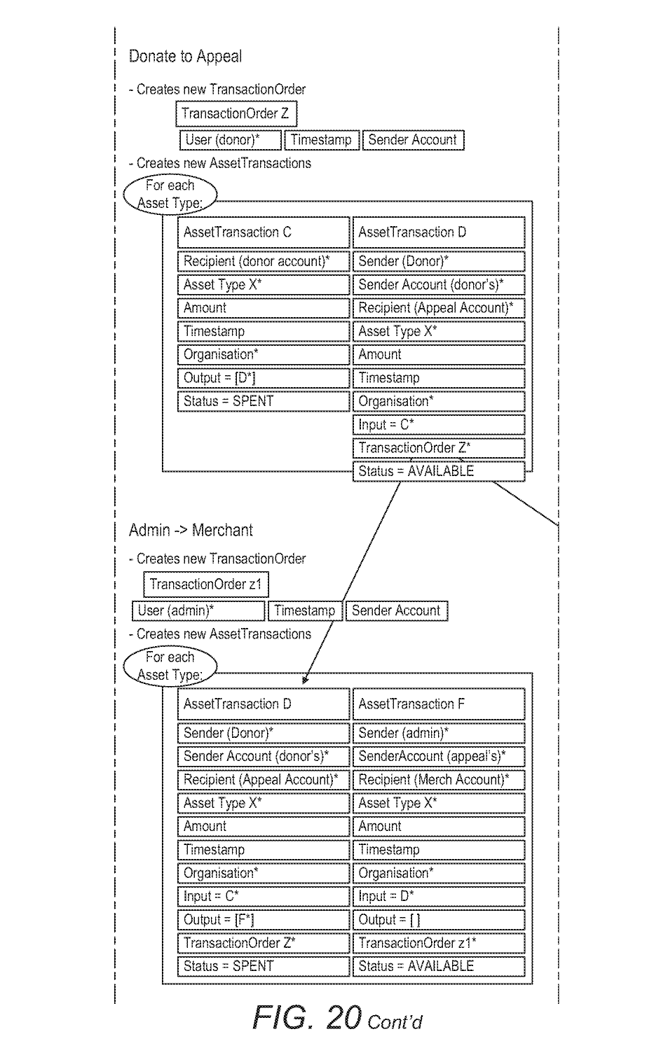

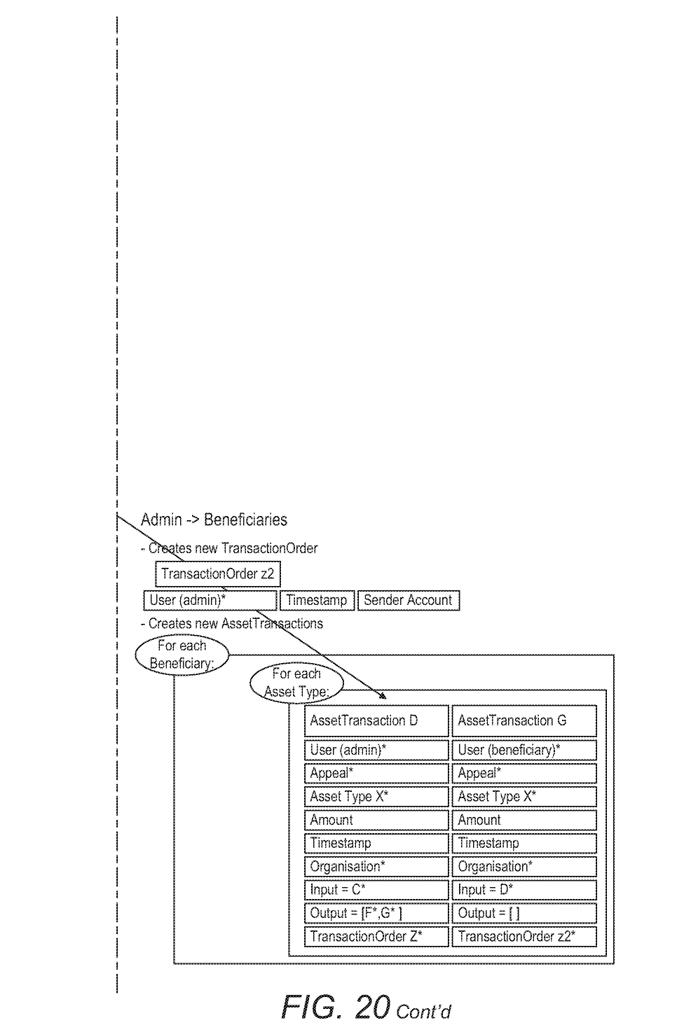

The system utilizes unspent transaction outputs (UXTO) in order to track the spending of money donated by remitter/donors. An unspent transaction output (UTXO) is an output of a blockchain transaction that has not been used as an input in a new transaction. For example, if two donors D1 and D2 were to each donate $50 for use by a particular beneficiary and the beneficiary were to utilize $75 to acquire assets, then a UXTO would indicate the portion of the unused donation that can be used to identify what amount from each donor's contribution was utilized. This works by creating a UXTO corresponding to each donation when the ledger is updated with the donations. The UXTO indicates the output of the relevant blockchain transaction (the donation) that has not been used as input in a new transaction (the redemption of the donation by a beneficiary). By analyzing the UXTO for each donation, the unspent and spent amounts can be determined. UXTOs are implemented by defining an “AssetTx” (asset transaction) object with “inputs” and “outputs” of a specific “account” on the platform, with a “sender” that can be an approved user of the account (either a “donor”, “beneficiary”, “merchant” or “organizationAdmin”). UXTOs (as defined by asset transactions) are stored on the distributed ledger along with all other objects, as shown in, for example, FIG. 20.

After payment is received, the organization receives the funds at step 1205 and issues the assets at step 1206. The individual assets are then assigned to various beneficiaries at step 1207.

In the services phase, a beneficiary can access a beneficiary portal at step 1208, such as by presenting their beneficiary code to a merchant and accessing a merchant computing device. At step 1209 a type and amount of assets for redemption is selected and at step 1210 a merchant is selected. At step 1211 the transaction is confirmed and the physical assets and digital assets are transferred.

In the balancing phase the merchant accesses merchant portal at step 1212. At steps 1213 and 1214 automated transaction reporting occurs and the digital assets belonging to the merchant are transferred back to the organization at step 1215. The merchant is then paid an equivalent amount in currency at step 1216 and the assets are transferred to a treasury of the organization at step 1217. The treasury can be a part of the distributed ledger that stores assets needing to be assigned. Optionally, step 1217 and the treasury can be omitted and the assets can be reassigned to various beneficiaries, as discussed with respect to step 1207.

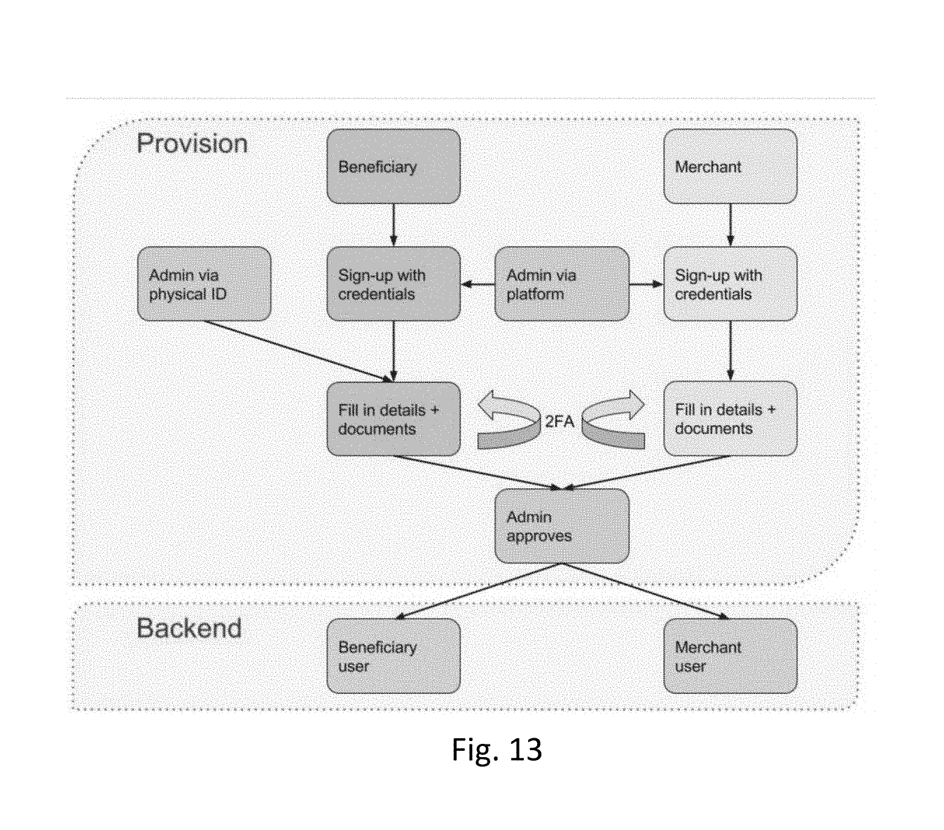

FIG. 13 illustrates a provisioning workflow according to an exemplary embodiment. As shown in FIG. 13, in a provisioning stage both a beneficiary (or a non-beneficiary recipient) and a merchant can provide the appropriate credentials to sign-up with a particular aid provider. An admin can also initiate the sign up process via the platform. After the relevant documentation is filled in and approved by an admin, the beneficiary user and the merchant user can be created and added to the distributed ledger. Provisioning can include creating an account by providing an email address and phone number, some personal details (e.g. Name, DOB, Country of Origin) as well as a password, generating a random “secret seed” from which the address on the ledger is derived, validating email, performing two-factor authentication on a first login using a phone number, recording personal information, and storing personal information in an encrypted SQL database. Additionally, a photograph can be taken of the individual, and a proof of ID (passport) and/or address (utility bill) can uploaded and stored in encrypted storage.

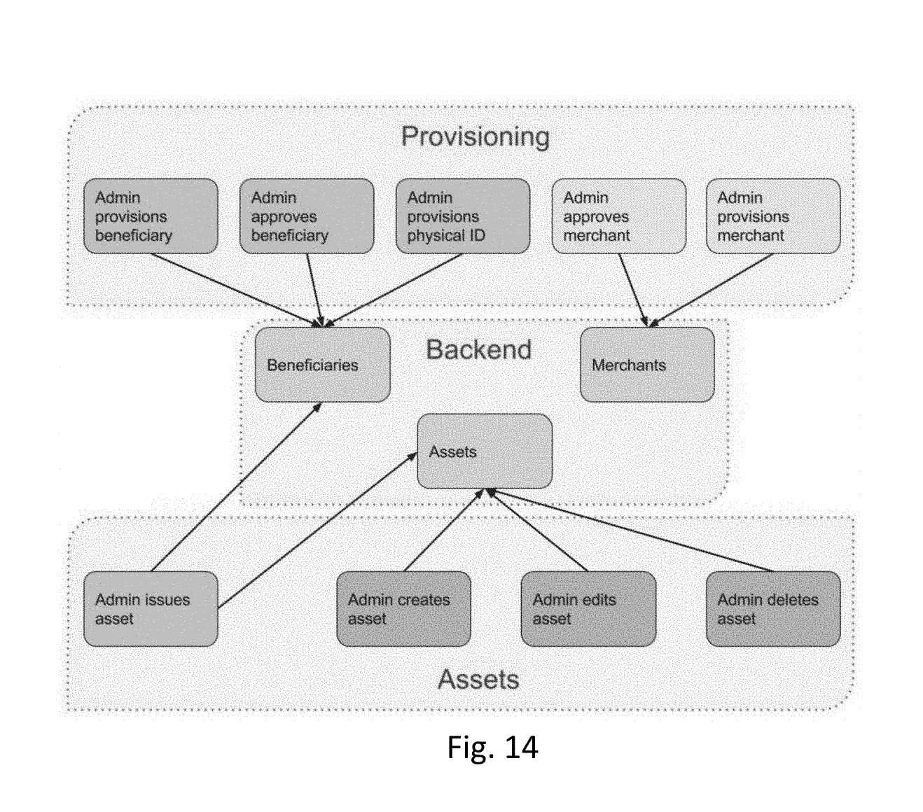

FIG. 14 illustrates an administrative workflow according to an exemplary embodiment. As shown in FIG. 14, the admin is responsible for approving and provisioning beneficiaries, physical identifications, and merchants and is also response for creating, editing, issuing, and deleting assets.

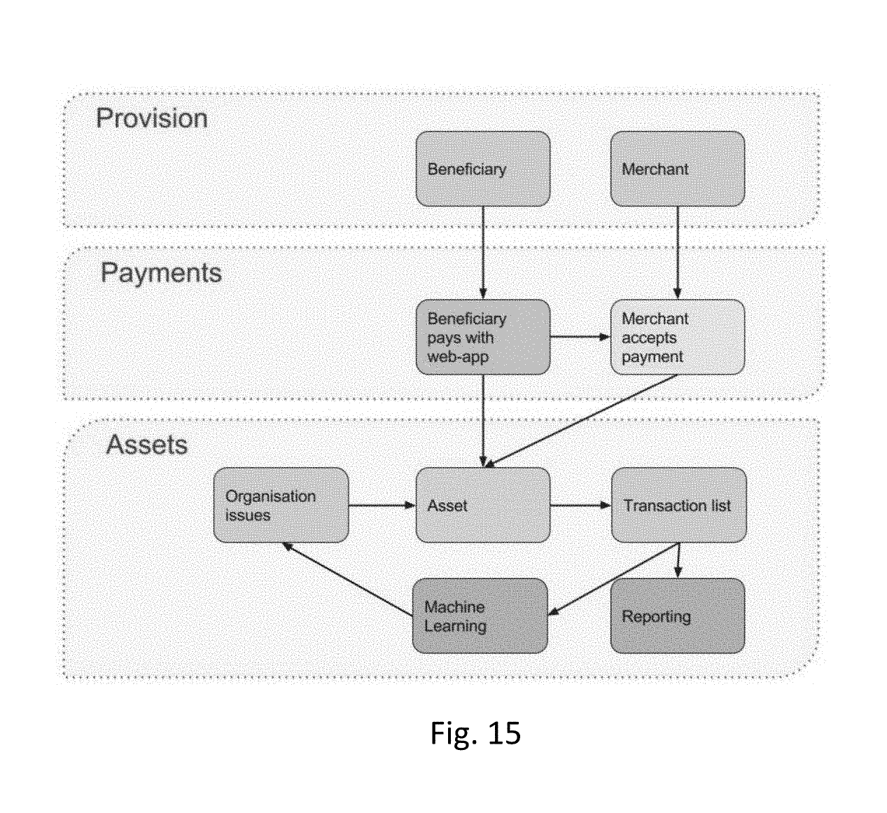

FIG. 15 illustrates a macro workflow according to an exemplary embodiment. As shown in FIG. 15, after provisioning, a beneficiary can pay a merchant with a web-app (or other means as discussed earlier) and the merchant can accept payments. The issued assets can then be transferred to the merchant and the transaction list can be reported as part of automatic transaction reporting (to be used in balancing the merchant's accounts). The transaction list can also be utilized for machine learning processes to identify and track consumption of assets by beneficiaries and to guide subsequent provisioning of assets and assignment of assets to beneficiaries. Additionally, machine learning is utilized to determine consumption of physical assets from various merchants and guide provisioning of physical assets to merchants.

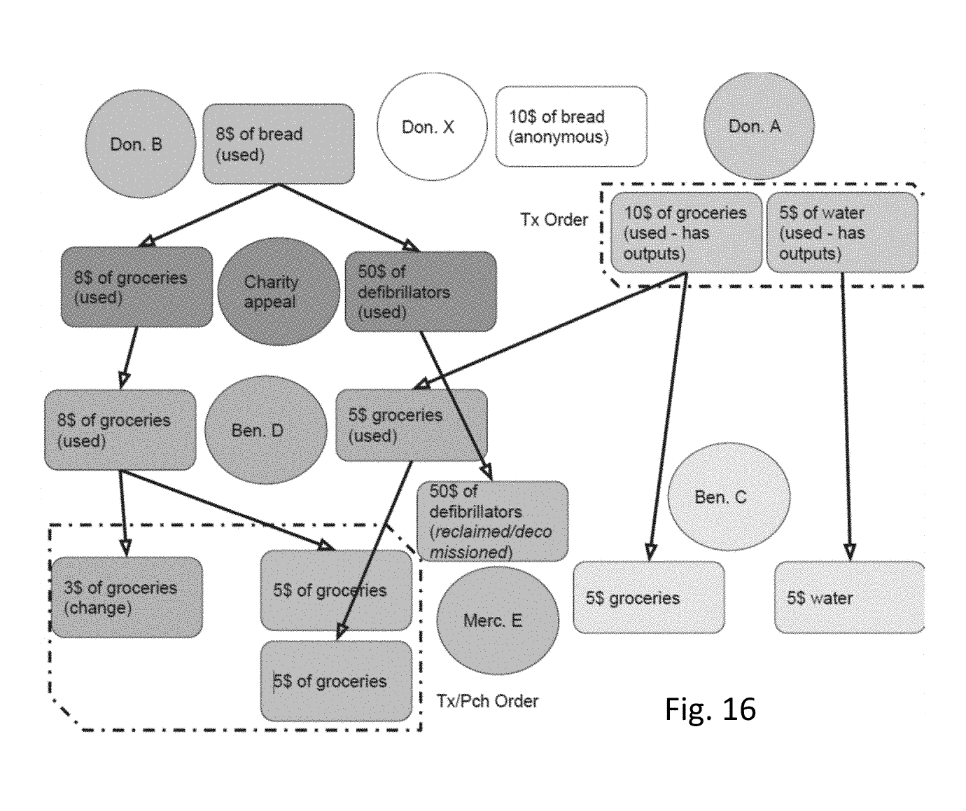

The aid distribution platform disclosed herein is configured to provide traceability of funds provided by donors, funds utilized by beneficiaries, and asset distribution. FIG. 16 illustrates asset transactions and order flow according to an exemplary embodiment. As shown in FIG. 16, usage of donations from individual donors (“Don) can be tracked to individual beneficiaries (“Ben”) and merchants (“Merc.”). FIG. 16 additionally tracks donations through individual charity appeals. An appeal is a category to which donors can donate to if they don't wish to donate to one or more separate individuals, but to a specific purpose (e.g. “Flooding in Haiti”, “Medical help for Syrian refugees”, “Climate change call”), and then the charity can directly spend these funds (with merchants registered on the platform) or redistribute to beneficiaries.

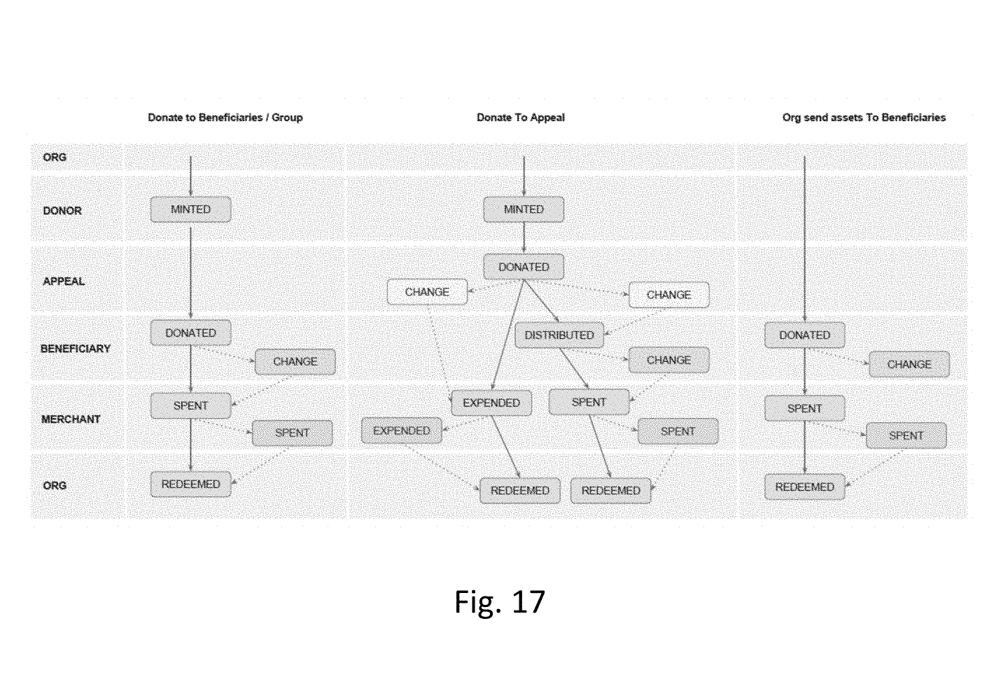

FIG. 17 illustrates asset transaction stages according to an exemplary embodiment. As shown in FIG. 17, assets can be minted by the organisation and then donated by donor to charities, via an appeal, or directly to specified beneficiaries. An organization can also donate assets directly to specified beneficiaries. Beneficiaries then spend the assets at merchants, who then redeem the spent assets from the organization.

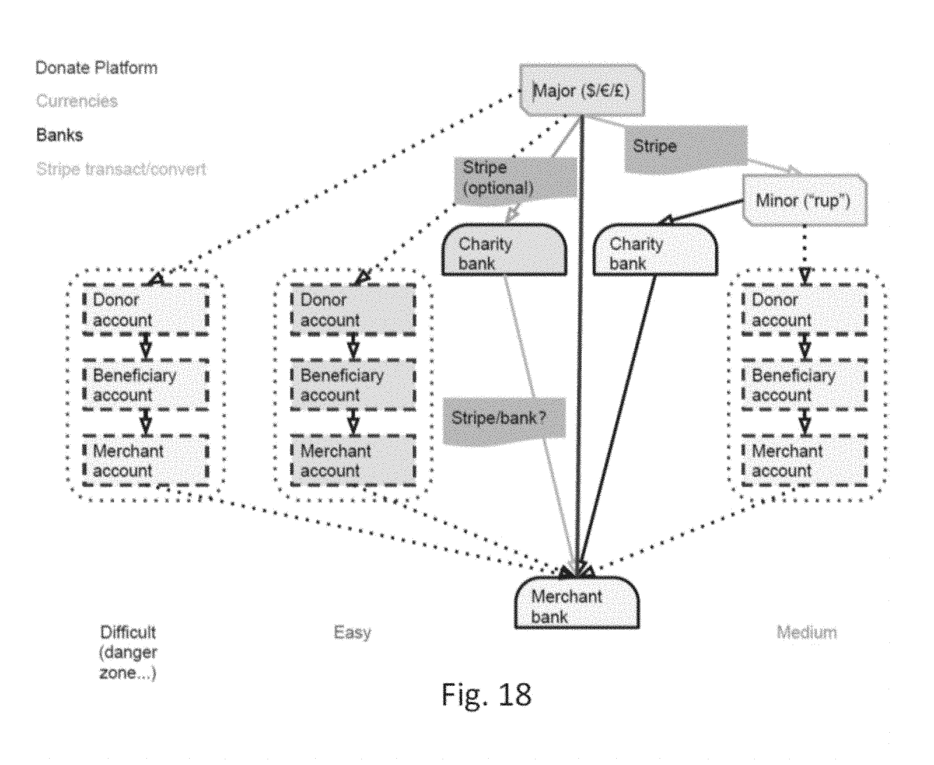

FIG. 18 illustrates a process for currency conversion according to an exemplary embodiment. As shown in FIG. 18, major currencies can be processed and converted into minor currencies prior to deposit in a donor, beneficiary, or merchant account on the platform.

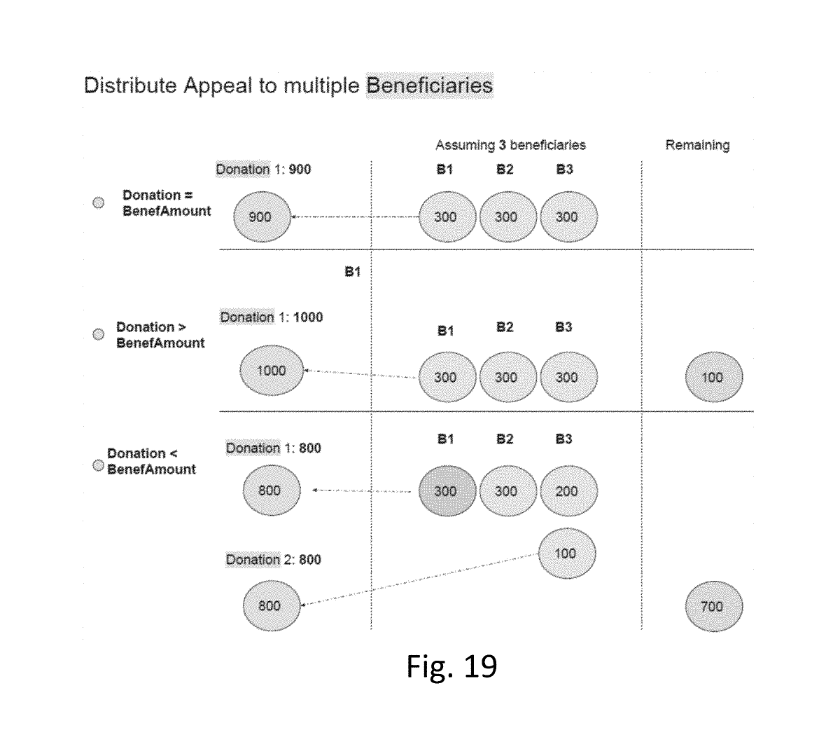

FIG. 19 illustrates a process for distributing donations from charity/appeal account to multiple beneficiaries according to an exemplary embodiment. Donations are divided equally among beneficiaries. When the donation is equal to a total benefit amount allocated to beneficiaries, no remainder amount is stored in the donor or charity/appeal account. When the donation is more than a total benefit amount allocated to beneficiaries, the remainder is stored in the donor or charity/appeal account in the form of unspent donation (UXTO, as discussed earlier). When the donation is less than a total benefit amount allocated to beneficiaries, a second donation is used to make up the difference and the remainder is stored in the donor or charity/appeal account as unspent donation.

FIG. 20 illustrates a transactions structure for different transactions on the platform according to an exemplary embodiment. As shown in FIG. 20, each transaction order results in the creation of new asset transactions for each asset type. The attributes of each new asset transaction, in turn, are determined based in part on the incoming asset transaction.

The platform disclosed herein allows for completely transparency and accountability. Each transaction in the distributed ledger includes a transaction identifier, along with the corresponding private key signatures, timestamps, and asset information. Furthermore, since the distributed ledger is built upon Blockchain, the digital assets cannot be tampered with and/or used for any purpose outside of the intended aid delivery.

As discussed above, the systems and methods described herein can be used in a variety of commercial or non-profit contexts. For example, the techniques and data structures described herein can be utilized to perform sales of physical assets to consumers, delivery of gifts to gift recipients in conjunction with an electronic purchase by gift-givers. The methods, systems, and data structures used herein can also be utilized to provide and distribute entitlements and assets such as welfare, remittances, healthcare, donations and aid.

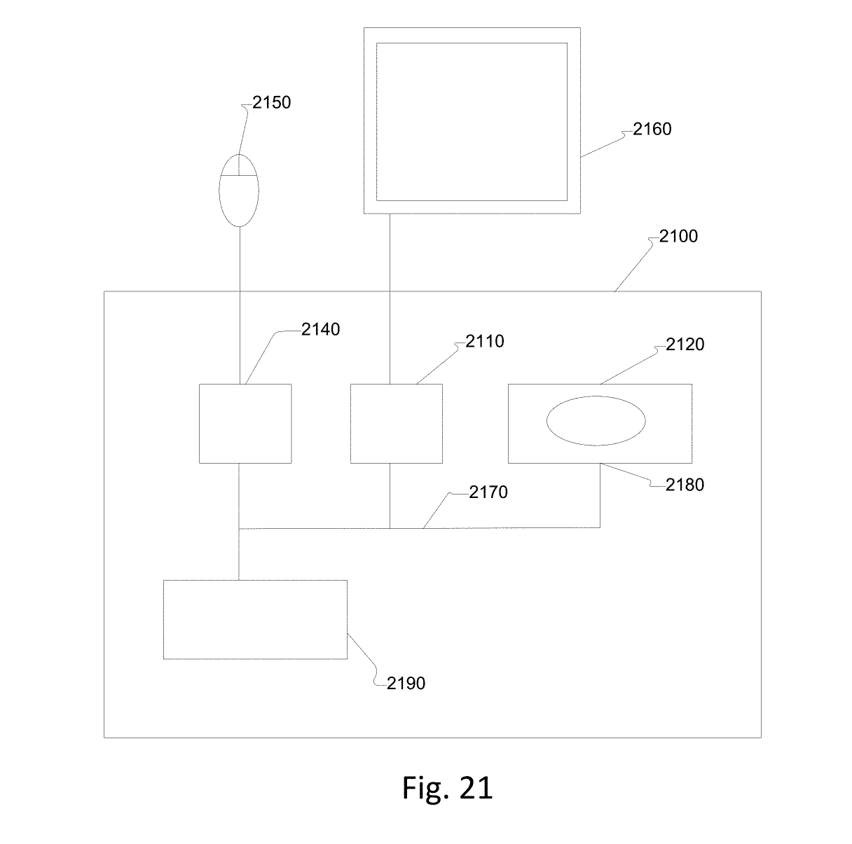

One or more of the above-described techniques can be implemented in or involve one or more computer systems. FIG. 21 illustrates an example of a computing environment 2100. The computing environment 2100 is not intended to suggest any limitation as to scope of use or functionality of a described embodiment(s).

With reference to FIG. 21, the computing environment 2100 includes at least one processing unit 2110 and memory 2120. The processing unit 2110 executes computer-executable instructions and can be a real or a virtual processor. In a multi-processing system, multiple processing units execute computer-executable instructions to increase processing power. The memory 2120 can be volatile memory (e.g., registers, cache, RAM), non-volatile memory (e.g., ROM, EEPROM, flash memory, etc.), or some combination of the two. The memory 2120 can store software 2180 implementing described techniques.

A computing environment can have additional features. For example, the computing environment 2100 includes storage 2140, one or more input devices 2150, one or more output devices 2160, and one or more communication connections 2190. An interconnection mechanism 2170, such as a bus, controller, or network interconnects the components of the computing environment 2100. Typically, operating system software or firmware (not shown) provides an operating environment for other software executing in the computing environment 2100, and coordinates activities of the components of the computing environment 2100.

The storage 2140 can be removable or non-removable, and includes magnetic disks, magnetic tapes or cassettes, CD-ROMs, CD-RWs, DVDs, or any other medium which can be used to store information and which can be accessed within the computing environment 2100. The storage 2140 can store instructions for the software 2180.

The input device(s) 2150 can be a touch input device such as a keyboard, mouse, pen, trackball, touch screen, or game controller, a voice input device, a scanning device, a digital camera, remote control, or another device that provides input to the computing environment 2100. The output device(s) 2160 can be a display, television, monitor, printer, speaker, or another device that provides output from the computing environment 2100.

The communication connection(s) 2190 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations can be described in the context of computer-readable media. Computer-readable media are any available media that can be accessed within a computing environment. By way of example, and not limitation, within the computing environment 2100, computer-readable media include memory 2120, storage 2140, communication media, and combinations of any of the above.

Of course, FIG. 21 illustrates computing environment 2100, display device 2160, and input device 2150 as separate devices for ease of identification only. Computing environment 2100, display device 2160, and input device 2150 can be separate devices (e.g., a personal computer connected by wires to a monitor and mouse), can be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). Computing environment 2100 can be a set-top box, personal computer, or one or more servers, for example a farm of networked servers, a clustered server environment, or a cloud network of computing devices.

Having described and illustrated the principles of our invention with reference to the described embodiment, it will be recognized that the described embodiment can be modified in arrangement and detail without departing from such principles. Elements of the described embodiment shown in software can be implemented in hardware and vice versa.

In view of the many possible embodiments to which the principles of our invention can be applied, we claim as our invention all such embodiments as can come within the scope and spirit of the following claims and equivalents thereto.

We claim:

1. A method executed by one or more computing devices for performing digital asset transactions, the method comprising:
receiving, by at least one of the one or more computing devices, a beneficiary code associated with a beneficiary from a merchant computing device, the beneficiary code comprising a beneficiary identifier;
converting, by at least one of the one or more computing devices, the beneficiary identifier into an instance of a beneficiary data structure associated with the beneficiary, wherein the beneficiary data structure comprises a beneficiary address associated with the beneficiary in a distributed ledger;
transmitting, by at least one of the one or more computing devices, biographical information corresponding to the beneficiary to the merchant computing device;
receiving, by at least one of the one or more computing devices, a confirmation message from the merchant computing device confirming an identity of the beneficiary and indicating one or more physical assets for transfer to the beneficiary; and
generating, by at least one of the one or more computing devices, one or more transactions transferring one or more digital assets corresponding to the one or more physical assets from the beneficiary address associated with the beneficiary in the distributed ledger to a merchant address associated with the merchant in the distributed ledger based at least in part on receiving the confirmation message.

2. The method of claim 1, wherein the beneficiary data structure comprises a beneficiary private key associated with the beneficiary and a beneficiary signer object configured to sign transactions and further comprising:
signing, by at least one of the one or more computing devices, the one or more transactions with the beneficiary signer object using the beneficiary private key.

3. The method of claim 1, wherein transmitting biographical information corresponding to the beneficiary to the merchant computing device comprises:
retrieving the biographical information corresponding to the beneficiary using the beneficiary identifier; and
transmitting the biographical information to the merchant computing device.

4. The method of claim 2, wherein the confirmation message further comprises confirmation of an identity of the beneficiary based at least in part on the transmitted biographical information.

5. The method of claim 1, further comprising:
receiving, by at least one of the one or more computing devices, one or more asset codes corresponding the one or more physical assets from the merchant computing device; and
determining, by at least one of the one or more computing devices, the one or more digital assets corresponding to the one or more physical assets based at least in part on the one or more asset codes.

6. The method of claim 1, further comprising:
receiving, by at least one of the one or more computing devices, one or more physical quantities corresponding to the one or more physical assets from the merchant computing device;
wherein each transaction in the one or more transactions transfers a quantity of each digital asset equal to the corresponding physical quantity for a physical asset corresponding to that digital asset.

7. The method of claim 1, further comprising:
identifying, by at least one of the one or more computing devices, a plurality of digital assets located at the merchant address;
determining, by at least one of the one or more computing devices, a total value of a plurality of physical assets corresponding to the plurality of digital assets;
generating, by at least one of the one or more computing devices, a plurality of transactions removing the plurality of digital assets from the merchant address associated with the merchant in the distributed ledger; and
transferring, by at least one of the one or more computing devices, a quantity of currency corresponding to the total value into a bank account associated with the merchant.

8. The method of claim 7, further comprising:
signing, by at least one of the one or more computing devices, the plurality of transactions with a merchant signer object using a merchant private key.

9. The method of claim 1, wherein the distributed ledger comprises a block chain.

10. An apparatus for performing digital asset transactions, the apparatus comprising:
one or more processors; and
one or more memories operatively coupled to at least one of the one or more processors and having instructions stored thereon that, when executed by at least one of the one or more processors, cause at least one of the one or more processors to:
receive a beneficiary code associated with a beneficiary from a merchant computing device, the beneficiary code comprising a beneficiary identifier;
convert the beneficiary identifier into an instance of a beneficiary data structure associated with the beneficiary, wherein the beneficiary data structure comprises a beneficiary address associated with the beneficiary in a distributed ledger;
transmit biographical information corresponding to the beneficiary to the merchant computing device;
receive a confirmation message from the merchant computing device confirming an identity of the beneficiary and indicating one or more physical assets for transfer to the beneficiary; and
generate one or more transactions transferring one or more digital assets corresponding to the one or more physical assets from the beneficiary address associated with the beneficiary in the distributed ledger to a merchant address associated with the merchant in the distributed ledger based at least in part on receiving the confirmation message.

11. The apparatus of claim 10, wherein the beneficiary data structure comprises a beneficiary private key associated with the beneficiary and a beneficiary signer object configured to sign transactions and wherein at least one of the one or more memories has further instructions stored thereon that, when executed by at least one of the one or more processors, cause at least one of the one or more processors to:
signing, by at least one of the one or more computing devices, the one or more transactions with the beneficiary signer object using the beneficiary private key.

12. The apparatus of claim 10, wherein at least one of the one or more memories has further instructions stored thereon that, when executed by at least one of the one or more processors, cause at least one of the one or more processors to:
receiving, by at least one of the one or more computing devices, one or more asset codes corresponding the one or more physical assets from the merchant computing device; and
determining, by at least one of the one or more computing devices, the one or more digital assets corresponding to the one or more physical assets based at least in part on the one or more asset codes.

13. The apparatus of claim 10, wherein at least one of the one or more memories has further instructions stored thereon that, when executed by at least one of the one or more processors, cause at least one of the one or more processors to:
receiving, by at least one of the one or more computing devices, one or more physical quantities corresponding to the one or more physical assets from the merchant computing device;
wherein each transaction in the one or more transactions transfers a quantity of each digital asset equal to the corresponding physical quantity for a physical asset corresponding to that digital asset.

14. The apparatus of claim 10, wherein at least one of the one or more memories has further instructions stored thereon that, when executed by at least one of the one or more processors, cause at least one of the one or more processors to:
identifying, by at least one of the one or more computing devices, a plurality of digital assets located at the merchant address;
determining, by at least one of the one or more computing devices, a total value of a plurality of physical assets corresponding to the plurality of digital assets;
generating, by at least one of the one or more computing devices, a plurality of transactions removing the plurality of digital assets from the merchant address associated with the merchant in the distributed ledger; and
transferring, by at least one of the one or more computing devices, a quantity of currency corresponding to the total value into a bank account associated with the merchant.

15. At least one non-transitory computer-readable medium storing computer-readable instructions that, when executed by one or more computing devices, cause at least one of the one or more computing devices to:
receive a beneficiary code associated with a beneficiary from a merchant computing device, the beneficiary code comprising a beneficiary identifier;
convert the beneficiary identifier into an instance of a beneficiary data structure associated with the beneficiary, wherein the beneficiary data structure comprises a beneficiary address associated with the beneficiary in a distributed ledger;
transmit biographical information corresponding to the beneficiary to the merchant computing device;
receive a confirmation message from the merchant computing device confirming an identity of the beneficiary and indicating one or more physical assets for transfer to the beneficiary; and
generate one or more transactions transferring one or more digital assets corresponding to the one or more physical assets from the beneficiary address associated with the beneficiary in the distributed ledger to a merchant address associated with the merchant in the distributed ledger based at least in part on receiving the confirmation message.

16. The at least one non-transitory computer-readable medium of claim 15, wherein the beneficiary data structure comprises a beneficiary private key associated with the beneficiary and a beneficiary signer object configured to sign transactions and further storing computer-readable instructions that, when executed by at least one of the one or more computing devices, cause at least one of the one or more computing devices to:
signing, by at least one of the one or more computing devices, the one or more transactions with the beneficiary signer object using the beneficiary private key.

17. The at least one non-transitory computer-readable medium of claim 15, further comprising:
receiving, by at least one of the one or more computing devices, one or more asset codes corresponding the one or more physical assets from the merchant computing device; and
determining, by at least one of the one or more computing devices, the one or more digital assets corresponding to the one or more physical assets based at least in part on the one or more asset codes.

18. The at least one non-transitory computer-readable medium of claim 15, further storing computer-readable instructions that, when executed by at least one of the one or more computing devices, cause at least one of the one or more computing devices to:
receiving, by at least one of the one or more computing devices, one or more physical quantities corresponding to the one or more physical assets from the merchant computing device;
wherein each transaction in the one or more transactions transfers a quantity of each digital asset equal to the corresponding physical quantity for a physical asset corresponding to that digital asset.

19. The at least one non-transitory computer-readable medium of claim 15, further storing computer-readable instructions that, when executed by at least one of the one or more computing devices, cause at least one of the one or more computing devices to:
identifying, by at least one of the one or more computing devices, a plurality of digital assets located at the merchant address;
determining, by at least one of the one or more computing devices, a total value of a plurality of physical assets corresponding to the plurality of digital assets;
generating, by at least one of the one or more computing devices, a plurality of transactions removing the plurality of digital assets from the merchant address associated with the merchant in the distributed ledger; and
transferring, by at least one of the one or more computing devices, a quantity of currency corresponding to the total value into a bank account associated with the merchant.
